(19) United States
(12) Patent Application Publication
(10) Pub. No.: US 2026/0322082 A1
(43) Pub. Date: Oct. 15, 2026

(54) RACKING DEVICE FOR MOVING A MOVABLE DRAWER OF A SWITCHGEAR

(71) Applicant: ABB S.P.A., Milano (IT)

(72) Inventors: Mingkun HE, Jiangmen (CN); Shanglin HUANG, Jiangmen (CN); Jiancheng REN, Jiangmen (CN); Yuning ZHANG, Jiangmen (CN)

(21) Appl. No.: 19/444,441

(22) Filed: Jan. 9, 2026

Related U.S. Application Data
(63) Continuation of application No. PCT/CN2023/117052, filed on Sep. 5, 2023.

(51) Int. Cl. H02B 11/127; H02B 3/00

(52) U.S. Cl. CPC H02B 11/127; H02B 3/00

(57) ABSTRACT

A racking device for moving a movable drawer of a switchgear includes a first output shaft movable between a retracted position and an extended position; a second output shaft configured to rotate a spindle on the movable drawer and a driver comprising a motor and a transmission mechanism coupled with the motor. The motor is configured to cause, based on an instruction for moving the movable drawer the first output shaft to linearly move to press the button in case that the second output shaft is not actuated, and to cause, based on the button being pressed down, the second output shaft to rotate the second output shaft with a second current greater than the first current to move the movable drawer

### FIELD

Embodiments of the present disclosure generally relate to a racking device for a switchgear and, more particularly, to a racking device for automatically moving a movable drawer of the switchgear with respect to a fixed part of the switchgear.

### BACKGROUND

Electrical switchgears (or just called switchgear) are widely used in power distribution systems. The switchgear includes switching devices, such as circuit breakers, in a primary electrical circuit configured to be operated to open and/or close the circuit. The switchgear typically includes a fixed part generally arranged in the primary electrical circuit and a movable part (or just called drawer) configured to engage or disengage from the fixed part. The drawer is movable among a plurality of positions, for example, a connection position at which the drawer engages the fixed part, a test position at which drawer disengages from the fixed part but a secondary electrical circuit for controlling the drawer is closed, a disconnecting position at which both the primary electrical circuit and the secondary electrical circuit are open.

To manually move the drawer into or out of the switchgear is typically dangerous since there is always a possibility that an explosion will occur due to a fault creating an arc flash, causing significant injury, or even death to the operator. A remote racking device is designed for moving the drawer into or out of the switchgear in response to operator's instructions. Since the drawer can be remotely controlled to racked from one position to another (e.g., from a connected position to a test position), the safety of the system can be improved. However, the conventional remote racking device is not satisfactory in terms of performances and there is a need to further improve the remote racking device.

### SUMMARY

Example embodiments of the present disclosure provide a racking device, a method for operating the racking device, and a switchgear with improved performances.

In a first aspect of the present disclosure, there is provided a racking device for moving a movable drawer of a switchgear. The racking device comprise: a first output shaft configured to linearly move between a retracted position and an extended position at which a button on the movable drawer is configured to be pressed down by the first output shaft; a second output shaft configured to rotate a spindle on the movable drawer to move the movable drawer with respect to a fixed part of the switchgear; and a driver comprising a motor and a transmission mechanism coupled with the motor, the transmission mechanism configured to actuate the second output shaft and the first output shaft. The motor is configured to cause, based on an instruction for moving the movable drawer, the first output shaft to linearly move to press the button in case that the second output shaft is not actuated, and to cause, based on the button being pressed down, the second output shaft to rotate the second output shaft with a second current greater than the first current to move the movable drawer. With this arrangement, the first output shaft is driven with a low current while the second output shaft is driven whit a large current. Smaller size of the racking device can be achieved, resulting in a compact, simple, and reliable device and making the device more convenient to carry, install and operate.

In some embodiments, the transmission mechanism may comprise a planetary gear clutch driven by the motor.

In some embodiments, the planetary gear clutch may comprise: a sun gear connected to the motor; a plurality of planet gears engaged with the sun gear; a carrier configured to support the plurality of planet gears and coupled with the second output shaft to rotate the second output shaft; and a ring gear engaged with the plurality of planet gears, wherein the ring gear is configured to linearly move the first output shaft at a predetermined circumferential position.

In some embodiments, the ring gear may comprise a pushing structure circumferentially provided at a side adjacent to the first output shaft and configured to linearly move the first output shaft in accordance with a circumferential position of the pushing structure.

In some embodiments, the device may further comprise at least one rotation resistance mechanism disposed between a housing of the racking device and the carrier and configured to provide a predetermined torque to prevent the carrier from rotating in case that the motor is operated with the first current. With the rotation resistance mechanism, the carrier is prevented from rotating when the motor is operated with the first current.

In some embodiments, the rotation resistance mechanism may comprise: a plurality of receiving portions circumferentially arranged in the carrier; a plurality of torsion springs disposed within the respective receiving portion; and a sliding member sandwiched between an inner surface of the housing and the torsion spring, the sliding member being configured to slide on the inner surface of the housing when the motor is operated with the second current. With the rotation resistance mechanism, the carrier is prevented from rotating when the motor is operated with the first current. By the plurality of receiving portions and the plurality of torsion springs, a bidirectional stability of the movement can be achieved.

In some embodiments, the plurality of receiving portions may be arranged in at least one axial end surface of the carrier and extends axially; one end of the plurality of torsion springs is received within the plurality of receiving portions; and the other end of the plurality of torsion springs is arranged against the sliding member. By the plurality of receiving portions and the plurality of torsion springs axially arranged, a bidirectional stability of the movement can be achieved.

In some embodiments, the plurality of receiving portions may be arranged in a circumferential outer surface of the carrier and extends radially; one end of the plurality of torsion springs is radially received within the plurality of receiving portions; and the other end of the plurality of torsion springs is arranged on the sliding member. By the plurality of receiving portions and the plurality of torsion springs radially arranged, a bidirectional stability of the movement can be achieved.

In some embodiments, the sliding member may comprise a pin-shaped member comprising a base part comprising a flat surface to abut against the inner surface of the housing; and a pin part extending from the based part and configured to support the torsion spring.

In some embodiments, the sliding member may comprise a plate-shaped member comprising a plate comprising a flat surface to abut against the inner surface of the housing; and a recess provided in a surface of the plate opposite to the flat surface and configured to receive the torsion spring.

In some embodiments, the receiving portion may comprise one of an opening, a groove, a recess, or a hole.

In some embodiments, the device may further comprise a locking mechanism at a predetermined circumferential position and configured to prevent the ring gear from rotating along a circumferential direction, wherein the locking mechanism comprises a first stopper provided on one of the ring gear and the housing, and a second stopper provided on the other of the ring gear and the housing for cooperating with the first stopper.

In some embodiments, the first stopper may comprise a protrusion fixedly disposed on the one of the ring gear and the housing, and the second stopper comprises a stopper section for circumferentially engaging the protrusion to stop the protrusion, and a rail section for circumferentially guiding movement of the protrusion.

In some embodiments, the motor may be further configured to: rotate in a first direction with a test current; rotate, based on the rotation in the first direction being hindered, in a second direction opposite to the first direction with the first current, and rotate, based on the rotation in the first direction being not hindered, to rotate in the first direction with the first current.

In some embodiments, the device may further comprise a first sensing device (36) configured to send a first signal indicating that the button is pressed down, the motor being configured to stop rotating in response to receiving the first signal.

In some embodiments, the device may further comprise a second sensing device configured to send a second signal indicating that the second output shaft arrives at a predetermined position; and cause the motor to perform, in response to receiving the second signal, a reverse rotation for a predetermined period, with a reverse release current.

In a second aspect of the present disclosure, there is provided a switchgear. The switchgear comprises: a fixed part, a movable drawer configured to move among a plurality of predetermined positions with respect to the fixing part; and the racking device according to any of the first aspect configured to moving the movable drawer.

In a third aspect of the present disclosure, there is provided a method for operating a racking device according to any of the first aspect. The method comprises causing, based on an instruction for moving the movable drawer, the motor to operate with a first current to linearly move the first output shaft to press down the button in case that the second output shaft is not actuated; and causing, based on the button being pressed down, the motor to operate with a second current greater than the first current so as to rotate the second output shaft to move the movable drawer.

It would be appreciated that this summary is not intended to identify key features or essential features of embodiments of the present disclosure, nor is it intended to be used to limit the scope of the present disclosure. Other features of the present disclosure will become evident through the following description.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a perspective exploded view of switchgear including a fixed part and a drawer and a racking device for moving a movable drawer according to one example embodiment of the present disclosure;

FIG. 2 is a perspective schematic view of the racking device according to one example embodiment of the present disclosure;

FIG. 3 is a perspective exploded view of the racking device according to one example embodiment of the present disclosure as seen from one perspective;

FIG. 4 is a perspective exploded view of the racking device shown in FIG. 3 as seen from an opposite perspective;

FIG. 5 is a partial sectional schematic view of a driver of the racking device according to one example embodiment of the present disclosure;

FIG. 6 is a partial perspective view of a planetary gear clutch of the racking device, with the first output shaft located at a retracted position and merely a portion of a cover with a protrusion being shown;

FIG. 7 is a partial perspective view of the planetary gear clutch of the racking device, with the first output shaft located at an extended position which corresponds to a state at which a button is pressed down;

FIG. 8 is a partial perspective view of the planetary gear clutch of the racking device, with the ring gear located at a stop position at which the carrier starts to move so as to rotate the second output shaft;

FIG. 9 is a flowchart of a method for operating the racking device according to one example embodiment of the present disclosure; and

FIG. 10 is block diagram of an example device adapted to implement the method embodiments of the present disclosure.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.” The terms “first,” “second,” and the like may refer to different or same objects. Other definitions, explicit and implicit, may be included below. A definition of a term is consistent throughout the description unless the context clearly indicates otherwise.

According to the present disclose, a racking device for moving a movable drawer of a switchgear is provided. The racking device includes a driver comprising a motor and a transmission mechanism coupled with the motor. The motor is configured to operate with a small current to cause the transmission mechanism to output a small torque to press a button on a circuit breaker via a push lever and then to operate with a large current to cause the transmission mechanism to output a large torque to drive a spindle of the circuit breaker. With this arrangement, the racking device can be driven with lower power requirement for powering the racking device, resulting in a more compact, light-weight device.

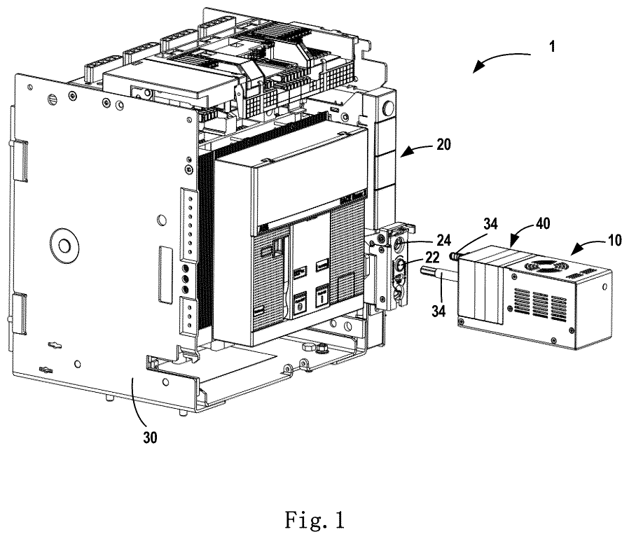

FIG. 1 is a perspective exploded view of a switchgear 1 according to one example embodiment of the present disclosure. As shown in FIG. 1, the switchgear 1 includes a fixed part 30 and a movable drawer 20. The movable drawer 20 is implemented as a circuit breaker. In the shown example, merely one drawer is shown to be arranged on part of the fixed part 30. It is to be understood that the shown example is merely illustrative, the switchgear may include a plurality of drawers and the fixed part 30 may be a cabinet form or any other proper forms. The movable drawer 20 is configured to be movable with respect to the fixed part 30 among various positions, for example, including a connected, test, and disconnected positions. The drawer can be moved from the connected positon to the test positon, and further to the disconnected position, or vice versa. For example, when maintenance of the switchgear is required, the drawer needs be moved from the connected positon to the test positon, and further to the disconnected position, or vice versa.

In order to move the movable drawer 20, the drawer may include interfaces for operating the drawer on its front panel. The interfaces may include an access hole 22 for receiving a handle. Rotation of the handle causes a spindle of the drawer to rotate. Rotation of the spindle causes the drawer to move into or out of the fixed part of the switchgear. The interfaces further include a button 24. The button 24 is provided for safety reason. Only when the button 24 is pressed down, the spindle is allowed to rotate. The button 24 normally pops up when the drawer is at the respective predetermined positions. At these positions, the spindle of the drawer is locked and is prevented from rotation. When the button 24 is pressed down, which indicates that the drawer is safe to operate, the spindle of the drawer is allowed to rotate. Only at this state, it is permissible for an operator to move the drawer. The interfaces may also include a position indicator 26 which indicates the position of drawer. Via the position indicator 26, the operator can know the operation states or the positions of the drawer, for example, connected, test, and disconnected positions.

As mentioned at background of the invention, there is always a possibility that an explosion will occur in the switchgear due to a fault creating an arc flash, causing significant injury, or even death to the operator. It is dangerous to manually move the drawer out of or into the switchgear. As shown in FIG. 1, in the system, a racking device 10 is provided to move the drawer. The racking device may be coupled to the drawer at the interfaces and is configured to move components on the interfaces so as to move the drawer. The racking device 10 may have matching interfaces for cooperating with the corresponding interfaces on the drawer. The racking device 10 may include a push lever 34 (corresponding to the push lever 34) configured to press the button 24 on the drawer. The racking device 10 may include a power shaft 32 (corresponding to the second output shaft) 32 configured to be inserted into the access hole 22 on the drawer. The power shaft is allowed to output a torque for rotating the spindle of the drawer when the button 24 is pressed down. With the racking device 10, it makes possible for the operator to remotely move the drawer without accessing the drawer.

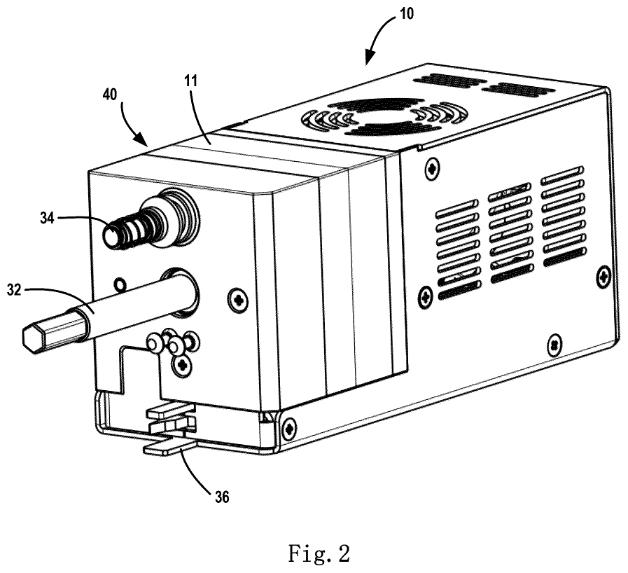

FIG. 2 is a perspective schematic view of the racking device 10 according to one example embodiment of the present disclosure. As shown in FIG. 2, the racking device 10 may be a form of box and may be used as an accessory of the switchgear. When there is a need to move the drawer, the racking device 10 can be coupled to the interfaces of the drawer. The racking device 10 may be self-powered or may be connected the mains supply. After the racking device 10 is coupled to the drawer in position, the racking device 10, for example, may be remotely controlled. Thus, the racking device can be controlled by the operator without accessing the switchgear.

The racking device 10 may include a casing or a bracket. Various components, the driver, the motor, and the associated control circuits, and the like may be assembled onto/into the casing. As shown in FIG. 2, a push lever 34 and a power shaft 34 are provided on one end of the racking device 10. The racking device 10 may include a driver 40 configured to drive the push lever 34 and a power shaft 34. The push lever 34 may be used to press down the button 24 on the drawer. A linear movement of the push lever 34 can press down the button. The power shaft 34 may be received in the access hole 22 on the drawer. The rotation of the power shaft 34 can rotates the spindle on the drawer accordingly. The driver 40 may comprise or receive power from a motor and transmits the power to the push lever 34 and the power shaft 34. The control circuits are used for control of the motor. The control circuits may also be communicatively connected to a remote controller by a hard-wired or in a wireless manner. The control circuits thus can drive the motor in response to receiving the operator's instructions.

In the shown embodiments, the driver 40 may be formed as a separate component with its own housing 11. In this case, the driver may be separately made and then assembled to the casing. In some embodiments (not shown), the components of the driver 40 may be directly assembled onto the casing. As shown in FIG. 2, the racking device 10 may also include a sensing device 36 configured to detect the position of the drawer. The data from the sensing device 36 may be sent to the control circuits of the racking device which can control the operation of the motor at least partially based on the data from the sensing device 36.

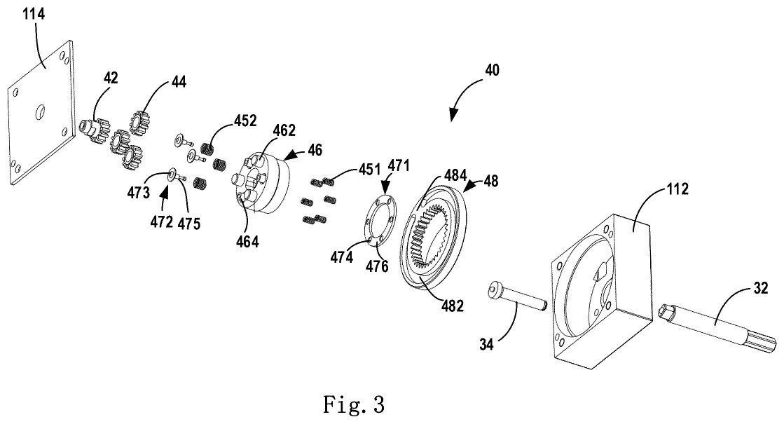

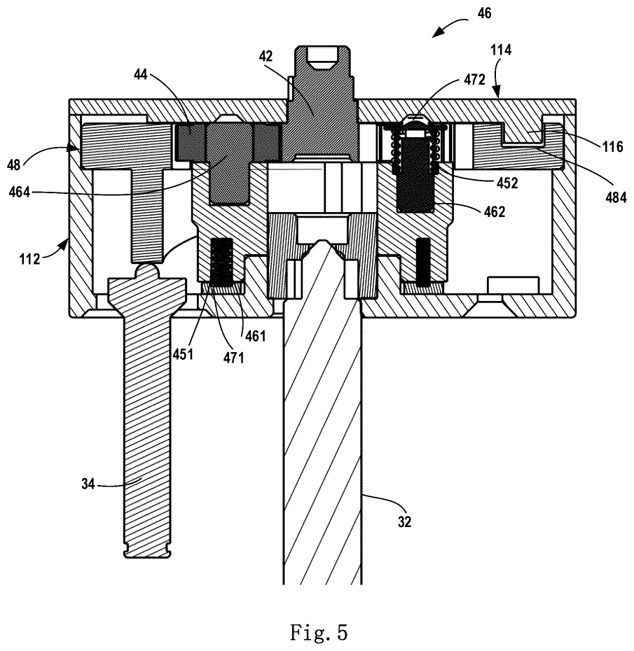

Structural details of the racking device are best illustrated in FIGS. 3-5. FIGS. 3-5 are perspective exploded views of the racking device according to one example embodiment of the present disclosure as seen from different perspectives. FIG. 5 is a partial sectional schematic view of the racking device according to one example embodiment of the present disclosure. It is to be understood that in the shown examples in FIGS. 3-5, merely essential parts of the racking device are shown and other unessential parts are omitted for sake of clarity.

As shown in FIGS. 3-5, the housing 11 may define a cavity and various functional components of the driver 40 may be arranged within the cavity. The housing 11 may be formed as various forms. In the shown example, the housing 11 may include a body part 112 at a first end defining the cavity and a cover 114 at an opposite second end for closing the cavity. In the shown example, the housing 11 is in a shape of box. The housing 11 may be of any other proper forms. The housing 11 may include interfaces for cooperating with the corresponding interfaces on the drawer at the first end.

The push lever 34 is configured to move linearly toward or away from the housing 11. When the push lever 34 is located at a retracted position, the push lever 34 cannot press down the button. When the push lever 34 is located at an extended position, the push lever 34 is configured to press down the button 24 on the drawer. Holes may be provided on the housing 11 which allows passage of the push lever 34.

The power shaft 34 is configured to rotate the spindle of the drawer. One end of the power shaft 34 may be inserted into the access hole 22 of the drawer and the other end of the power shaft 34 is connected to the driver 40. The driver 40 may be installed in the cavity defined by the housing 11. The driver 40 may include a transmission mechanism coupled with the motor. The transmission mechanism is configured to actuate both the push lever 34 and the power shaft 34 by supplying the motor with a small current and a large current respectively. Since the motor is configured to drive both the push lever 34 and the power shaft 34, there is no need to provide two sets of mechanisms for driving the push lever 34 and the power shaft 34 respectively. A size of the racking device 10 can be reduced, resulting in a light-weight design.

The racking device 10 may also include a remote controller (not shown) which communicate with a controller of the motor and is configured to receive user's input commands. The remote controller may include an input device, such as a keyboard. In some embodiments, the remote controller may include a display which can show operation status of the racking device 10, and other information. When there is a need to move the drawer, for example, under a maintenance situation, the remote controller may receive commands from the user. In accordance with the instruction for moving the drawer from the operator, the motor is configured to operate with a small current. When the motor is driven with the small current, the push lever 34 is caused to move to the extended position from the retracted position while the power shaft 34 does not move. When the push lever 34 is moved to the extended position, the button 24 is pressed down and the spindle of the drawer is thus allowed to rotate. After the button 24 being pressed down, the power shaft 34 is caused to move with a large current. With the large current, the power shaft 34 is caused to rotate so as to move the drawer from the initial positon to a second predetermined position.

In some embodiments, the transmission mechanism may include a planetary gear clutch driven by a single motor. When the clutch is driven by the motor with the small current, the push lever 34 is linearly moved and the power shaft 34 is stationary with respect to the housing 11. When the clutch is driven by the motor with the large current, the push lever 34 is stationary at a predetermined position and the power shaft 34 is rotated. It is to be understood that the planetary gear clutch is merely illustrative and the clutch may take any other proper forms.

In some embodiments, as shown in FIGS. 3-5, the planetary gear clutch may include a sun gear 42, a plurality of planet gears 44, a carrier 46, and a ring gear 48. The sun gear 42 is connected to the motor (not shown) and receives power from the motor. The planet gears 44 engage with the sun gear 42 and the ring gear 48. The carrier 46 includes a coupling shaft 464 for supporting the planet gears 44. The ring gear 48 is configured to drive the push lever 34. When the ring gear 48 rotates to a certain circumferential position, the push lever 34 is linearly moved by the ring gear 48. The push lever 34 may be held within the retracted position when the ring gear 48 does not rotate. When the ring gear 48 rotate to a predetermined circumferential angle, the ring gear 48 drives the push lever 34 to move.

In some embodiments, the ring gear 48 may include a pushing structure 486 circumferentially arranged adjacent to the push lever 34. The pushing structure 486 may include a height changing structure. The height change of the pushing structure 486 may provide a linear movement stroke of the push lever 34. In the shown example, the pushing structure 486 is shown as a circumferential protrusion 116 including an inclination surface. It is to be understood the shown example is merely illustrative and the pushing structure 486 may be of any other proper forms.

The carrier 46 is configured to support the planet gears 44. The carrier 46 is also coupled with the power shaft 34 adjacent to one end of the housing 11. When the motor operates with a small current, the carrier 46 does not rotate but the ring gear 48 rotates. When the motor operates with a large current, the carrier 46 is caused to rotate. When the carrier 46 rotates, the power shaft 34 rotates accordingly. The spindle of the drawer rotates accordingly. Accordingly, the drawer can be moved via rotation of the power shaft 34.

In some embodiments, the racking device 10 further includes a rotation resistance mechanism for the carrier 46. The rotation resistance mechanism is configured to provide a predetermined torque which serves as a resistance to stop the carrier 46 from moving when the motor is operated with the small current. When the motor is operated with the large current, a large torque caused by the large current is greater than the predetermined torque. When the large torque is applied to the carrier 46, the carrier 46 rotates accordingly.

The rotation resistance mechanism may be of various forms. In some embodiments, the rotation resistance mechanism is disposed between the housing 11 and the carrier 46 and is configured to provide a predetermined torque to prevent the carrier 46 from rotating when the motor is operated with the first current. In some embodiment, the rotation resistance mechanism may be axially arranged between the housing 11 and the carrier 46. For example, the rotation resistance mechanism may be arranged between one axial end surface of the carrier 46 and an inner surface of housing 11 for example, an axial inner surface of the cover. In some embodiment, the rotation resistance mechanism may be radially arranged between the housing 11 and the carrier 46. For example, the rotation resistance mechanism may be arranged between a circumferential outer surface of the carrier 46 and an inner surface of housing 11 for example, a lengthwise inner surface of the body part of the housing 11.

In some embodiments, there are more than one rotation resistance mechanisms. As shown in FIGS. 3-5, there are two rotation resistance mechanisms which are axially arranged. A first rotation resistance mechanism is arranged at one axial end surface of the carrier 46 and an inner surface of the cover 114, and a second rotation resistance mechanism is arranged at other axial end surface of the carrier 46 and an inner surface of bottom portion of the body part 112. It is to be understood that the shown example are merely illustrative that there may be merely one rotation resistance mechanism or more than two rotation resistance mechanisms.

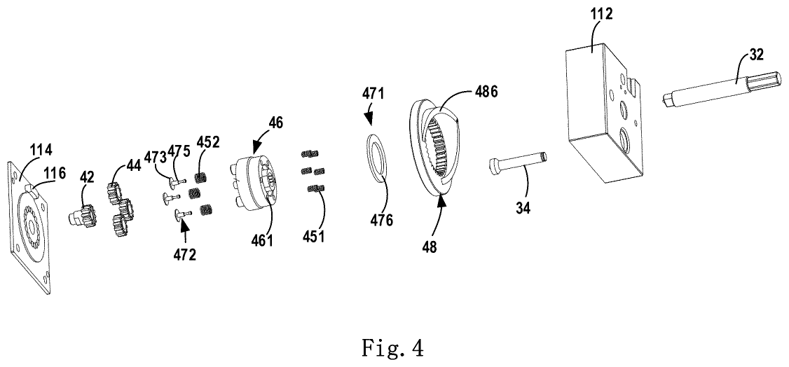

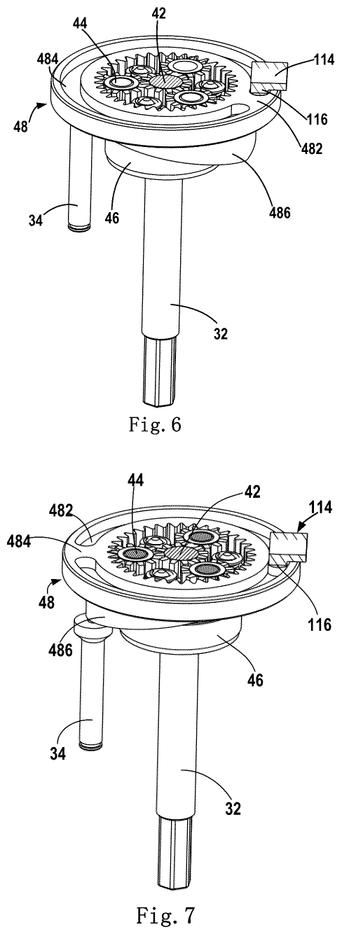

As shown in FIGS. 3-5, the first rotation resistance mechanism may be formed by a plurality of torsion springs 451 which are circumferentially arranged. A plurality of receiving portions 461 are axially and circumferentially arranged in the carrier 46. The plurality of torsion springs 451 may be axially received within the respective receiving portions 461. In the shown example, there are six receiving portions 461 and six torsion springs 451. It is to be understood that the shown example are merely illustrative and the number of the receiving portions 461 and six torsion springs 451 may be two, three, four, five, or more. The plurality of torsion springs 451 may be evenly arranged around the power shaft 32. In some embodiments, as shown in FIGS. 4 and 6, the receiving portion 461 may be lengthwise deep groove in which the torsion springs 451 are received. In this case, most of a spring body of the torsion spring 451 can be accommodated in the grove, which may improve stability of force transmission. It is to be understood that the receiving portion 461 may be any other proper forms as long as the torsion springs 451 are stably held. In some embodiments, the receiving portion 462 may be an opening, a recess, or a hole, and the like.

For each torsion spring, a sliding member 471 may be sandwiched between an inner surface of the cover 114 and the torsion spring 451. The plurality of receiving portions 461 is arranged in axial end surface of the carrier 46 and extends axially. One end of the plurality of torsion springs 451 is axially received within the plurality of receiving portions 461. The other end of the plurality of torsion springs 451 is arranged on the sliding member 471. The sliding member 471 may be movable with respect to the cover 114. At an initial state, the sliding member 471 is compressed by the torsion springs 451 against the cover 114. When the motor is operated with a small current, the sliding member 471 does not move with respect to the housing 11 and the carrier 46 is prevented from rotating due to the torque by the torsion springs 451. When the motor is operated with a large current, the sliding member 471 moves with respect to the housing 11 against the resistance of the torsion springs 451. The carrier 46 is allowed to rotate due to engagement between the sun gear 42 and the planet gear 44.

As show in FIGS. 3-5, the sliding member 471 is a plate-shaped member. The plate-shaped member may include a ring-shaped plate 476. The ring-shaped plate 476 may include a flat surface to abut against the inner surface of the housing 11 (in the shown example, an inner surface of the cover 114). The flat surface may form a surface contact with a corresponding surface of the housing 11. In the shown embodiment, the flat surface and the inner surface form a surface contact. Such a surface contact facilitates smooth movement of the carrier 46. A plurality of recesses 474 (for example, shallow recesses) are provided on a surface opposite to the flat surface. The recess may be configured to receive partial spring body of the torsion spring 50. In the shown example, the plurality of recesses 474 is evenly arranged around the power shaft 32. With this arrangement, the spring can be reliably and stably received within the recess of the plate-shaped member and the groove of the carrier 46. In the shown example, the recesses 474 of the sliding member 471 are used for support the torsion spring 50. It is to be understood that any other proper structure can be used to take place of the recesses 474 as long as the torsion spring 50 can be reliably held.

The sliding member 471 is thus compressed by the spring 50 against the cover 114. When the motor is operated with a small current, the sliding member 471, 472 do not move with respect to the housing 11 and the carrier 46 is prevented from rotating due to the torque by the torsion spring. When the motor is operated with a large current, the sliding member 471 moves with respect to the housing 11 and the carrier 46 is allowed to rotate. When the springs are axially received in grooves and the recess, the torque applied to the carrier 46 is stable which is advantageous for driving the motor. Also, the torque can be reliably and symmetrically applied to the carrier 46 from clockwise and anti-clockwise direction.

The second rotation resistance mechanism may take a similar configuration as the first rotation resistance mechanism. The second rotation resistance mechanism is analogues to the first rotation resistance mechanism but of slight differences. It is to be understood that the shown first and second rotation resistance mechanisms are merely illustrative, and the first and second rotation resistance mechanisms may be the same and may take any other proper configurations. With the two sets of the rotation resistance mechanism, the bidirectional stability of the carrier 46 can be improved. When the motor is operated with a small current, the carrier 46 can be kept stationary. When the motor is operated with a large current, the carrier 46 can be rotate with increased stability in both clockwise direction and anti-clockwise direction.

As shown in FIGS. 3-5, the second rotation resistance mechanism is arranged at other axial end surface of the carrier 46 and an inner surface of bottom portion of the body part 112. A plurality of receiving portions 462 extends axially from a second end surface of the carrier 46. The plurality of receiving portions 462 may be even circumferentially arranged around the power shaft. A plurality of torsion springs 452 may be axially received within the respective receiving portion 462. In the shown example, there are three receiving portions 462 and three torsion springs 452. It is to be understood that the shown example are merely illustrative and the number of the receiving portions 462 and six torsion springs 452 may be two, four, five or more. In the shown example, the receiving portion 462 is of a cylindrical shape with an axial hole. The torsion spring 452 may be received within the axial hole.

A sliding member 472 may be sandwiched between an inner surface of the bottom portion and the spring. One end of the plurality of torsion springs 452 is axially received within the plurality of receiving portions 462. The other end of the plurality of torsion springs 452 is arranged on the sliding member 472.

As show in FIGS. 3-5, the sliding member 472 is a pin-shaped member. The pin-shaped member includes a base part 473 and a pin part 475 extending from the based part 473. The base part 473 comprises a flat surface to abut against the inner surface of the housing 11. The sliding member 472 may be configured to form a surface contact with a corresponding surface of the housing 11 (in the shown example, an inner bottom surface of the body part). In the shown embodiment, the flat surface and the inner bottom surface form a surface contact. Such a surface contact facilitates smooth movement of the carrier 46. The pin part 475 may be received in turns of the spring and configured to support the spring. This may facilitate stability of the spring.

In the shown example, both the first rotation resistance mechanism and the second rotation resistance mechanism are axially arranged between the carrier 46 and the housing 11. It is to be understood that the shown example is merely illustrative and at least one of the first rotation resistance mechanism and the second rotation resistance mechanism may be circumferentially arranged between the carrier 46 and the housing 11. One or more rotation resistance mechanism may be circumferentially arranged around the carrier 46. For example, when one rotation resistance mechanism is provided, the rotation resistance mechanism may be centrally arranged. When two rotation resistance mechanisms are provided, the rotation resistance mechanisms may be arranged adjacent to the respective lengthwise end of the carrier 46.

In some embodiments (not shown), a plurality of receiving portion extends radially from an outer circumferential surface of the carrier 46. A plurality of torsion springs may be radially received within the receiving portion. Sliding members may be provided between an inner circumferential surface of the housing and the springs. Due to radial provision of the torsion springs, the predetermined torque for stopping the carrier from moving can be provided. The sliding members may be various forms. In some embodiments, one ring-shaped plate may be used as a sliding member and is arranged adjacent to the inner circumferential surface of the housing. In some embodiments, the sliding member may be of a pin-shaped member. It is to be understood that the shown example are merely illustrative and the sliding member may be of any other proper forms.

In some embodiments, the racking device 10 may include a locking mechanism configured to stop the ring gear 48 from rotating. Via rotation of the ring gear 48 along one circumferential direction, the button 24 is pressed down by the push lever 34 when the motor is operated with the first current. After the button 24 being pressed down, rotation of the ring gear 48 along the one circumferential direction can be stopped. If the rotation of the ring gear 48 along the one circumferential direction is stopped, all energy can be used to drive the carrier 46, in particular, when the motor is driven with the large current. This is advantageous in terms of energy efficiency.

As shown in FIGS. 3-5, the locking mechanism may include a first stopper provided on the housing 11 (in the shown example, the cover 114) and a second stopper provided on one axial end of the ring gear 48. When the first stopper abuts against the second stopper, the ring gear 48 is stopped from rotating. The first stopper and the second stopper may be of various forms. In the shown example, the first stopper is a protrusion 116 on the cover 114, and the second stopper includes a stopper section 484 configured to circumferentially engage the protrusion 116. As the ring gear 48 rotates, the protrusion 116 on the cover 114 is blocked by the stopper section 484 on the ring gear 48. Thus, the ring gear 48 stops and does not rotate any more.

In some embodiments, as shown in FIGS. 3 and 4, the protrusion 116 may be fixedly disposed on the cover 114. This may prevent the protrusion 116 from overriding the stopper section 484. When the protrusion 116 goes across the stopper section 484, the ring gear 48 cannot be stopped. There is a possibility that the ring gear 48 idles while the carrier 46 cannot be driven to rotate. When the protrusion 116 is fixedly disposed on the cover 114, the protrusion 116 cannot go across the stopper section 484 unless the protrusion 116 or the stopper section 484 is destroyed.

In some embodiments, as shown in FIGS. 3-5, the ring gear 48 may include an annular groove on an axial end surface opposite to the push lever 34. The annular groove may include a rail section 482 configured to circumferentially guide the protrusion 116. The stopper section 484 is located adjacent to the rail section 482. By guidance of the rail section 482, the stability of the movement of the protrusion 116 can be improved. In the shown example, the protrusion 116 is shown to be a cylinder form. This is merely illustrative and the protrusion 116 may be of any other proper forms. In the shown example, the protrusion 116 is provided on the housing 11 while the stopper section 484 is provided on the ring gear 48. It is to be understood that the shown example are merely illustrative and the above arrangement can be reversed.

In some embodiments, the racking device 10 may include various sensing devices. One sensing device 36 may include a position detection sensor configured to detect the position of the drawer, for example, a connected position, a test position, and a disconnected position. The position detection sensor may be arranged at the interfaces of the racking device 10 (also referring to FIG. 2). The motor may be configured to stop rotating based on a signal from the position detection sensor. In some embodiments, a second sensing device may include a second position detection sensor configured to detect the position of the power shaft 34. The second position detection sensor, for example, a micro-switch, may be arranged within the cavity. The motor may be configured to perform a reverse rotation for a short time with a reverse release current based on a signal from the second position detection sensor. By reverse rotation of the motor with the reverse release current, over-tension force in the clutch, for example among the gears, can be released. A lifetime of the clutch can be improved.

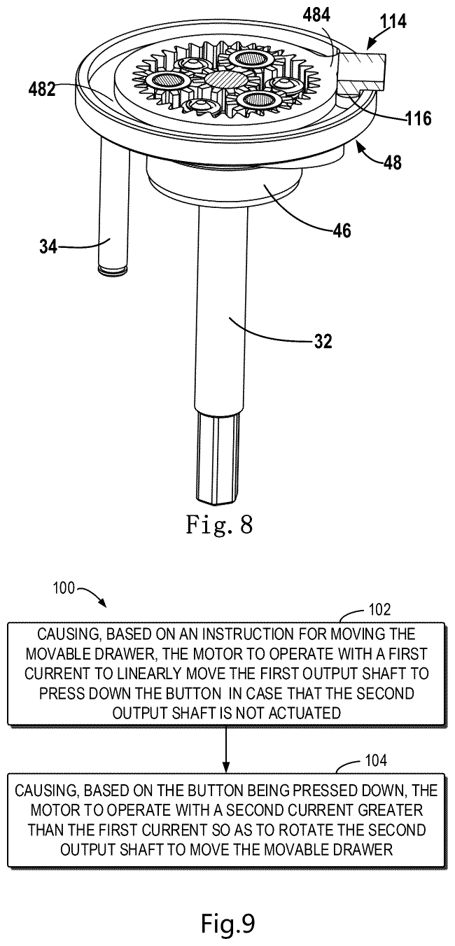

Operations of the racking device 10 and its associated control are described below by referring to FIGS. 6-8. FIGS. 6-8 show different perspective views of the planetary gear clutch of the racking device 10 at different operations stages. FIG. 6 shows an initial state during operation of the racking device 10. FIG. 7 is an intermediate state during operation of the racking device 10 after the motor is driven with a small current. FIG. 8 shows a subsequent state to the intermediate state at which the ring gear 48 stops and the carrier starts to rotate. In FIGS. 6-8, merely a part of the cover 114 that includes the protrusion 116 is shown and other parts of the housing 11 are omitted for sake of clarity.

As shown in FIG. 6, also referring to FIGS. 3 and 5, at one exemplary initial state, the push lever 34 is located at a retracted position. As seen in FIG. 6, the pushing structure 486 does not contact the push lever 34. When the racking device 10 receives an instruction from the operator to move the drawer, for example, from a connected position to a test position. The motor is instructed to be operated with a small current. The small current herein refers to a current which is not sufficient to overcome the predetermined resistance torque applied by the springs but is large enough to rotate the carrier 46. As the motor is connected to the sun gear 42, when the motor rotates, the sun gear 42 rotates accordingly. The sun gear 42 engages with the planet gears 44 which in turn engage with the ring gear 48. When the sun gear 42 rotates, the planet gears 44 rotate accordingly which in turn rotates the ring gear 48. At the same, due to the provision of the rotation resistance mechanism (in particular the torsion springs 451, 452), the torque generated by the small current is less than a resistance torque provided by the rotation resistance mechanisms, the carrier 46 is stopped from rotating.

As the ring gear 48 rotates, for example, to one predetermined circumferential position along one rotation direction, the pushing structure 486 on the ring gear 48 begins contacting the push lever 34. As the ring gear 48 continues rotating, the push lever 34 is driven to linearly move from the retracted position toward the extended position due to the height change of the pushing structure 486 on the carrier 48. This is best shown in FIG. 6. As shown in FIG. 7, when the pushing structure 486 arrives at the predetermined circumferential position, the push lever 34 arrives at the extended position. At this position, the button 24 on the drawer is pressed down by the pushing structure 486. Once the button 24 on the drawer is pressed down, the motor is instructed to operate with a large current. The large current herein refers to a current which is sufficient to overcome the predetermined resistance torque applied by the springs. When the motor is driven with the large current, the carrier 48 is driven to rotate. In some embodiments, a signal indicating the button 24 being pressed down may be provided by detecting a position of the push lever 34. It is to be understood that the signal indicating the button 24 being pressed down may be detected by any other proper means.

As shown in FIG. 8, as the ring gear 48 continues rotating along the rotation direction, the ring gear 48 arrives at the position shown in FIG. 8 from the intermediate position shown in FIG. 6. During rotation from the position shown in FIG. 6 to that in FIG. 7, the protrusion 116 on the cover 114 does not block the ring gear 48. But when the ring gear 48 rotates to the position as shown in FIG. 8, the stopper section 484 on the ring gear 48 engages with the protrusion 116 on the cover 114. The ring gear 48 is stopped from continuing rotating and stops accordingly. At this moment, the carrier 46 overcomes the predetermined resistance torque applied by the spring and begins to rotate.

As the carrier 46 rotates, the power shaft 34 rotates accordingly which in turn rotates the spindle of the drawer so as to move the drawer from the connected position to the test position. Once it is detected that the drawer arrives at the test position, the motor is instructed to stop rotating. The drawer thus can be automatically moved from the connected position to the test position.

In some embodiments, before the motor is driven by the small current, there is a need determine a rotation direction of the ring gear 48 from the initial state as shown in FIG. 6. This is advantageous in the case that the protrusion is fixedly formed on the cover. An initial relative position between the ring gear 48 and the housing 11 (in particular the cover 114) is not known by the racking device. If the protrusion is fixedly formed on the cover, the wrong rotation direction may damage the racking device. In some embodiments, a sensor for detecting the initial relative position between the ring gear 48 and the housing 11 may be provided. This may increase the cost of the racking device.

In some embodiments, no such a sensor is provided. The rotation direction can be determined by driving the motor with a test current. The test current should be large enough to rotate the ring gear 48 but is smaller than the large current. In some embodiments, the test current may be smaller or equal to the small current. The motor is instructed to attempt to rotate forward or backward to determine the rotation direction of the ring gear 48. In particular, the motor may be instructed to move in a first predetermined direction, for example, a clockwise direction for a short time with the test current. As shown in FIG. 6, as the ring gear 48 rotates in the clockwise direction due to the test current, the movement of the ring gear 48 may be detected. Once it is determined that the movement of the ring gear 48 is not hindered (which means the initial relative position between the ring gear 48 and the cover is shown as in FIG. 6, the clockwise rotation of the ring gear 48 being allowable), the ring gear 48 is instructed to rotate in the clockwise direction with the small current.

On the other hand, once it is determined that the movement of the ring gear 48 is hindered (which means the initial relative position between the ring gear 48 and the cover is shown as in FIG. 8, the clockwise rotation of the ring gear 48 being not allowable since the clockwise rotation of the ring gear 48 is blocked by the stopper section 484), the ring gear 48 is thus instructed to rotate in the anti-clockwise direction with the small current. By the test current, the rotation direction of the ring gear 48 can be determined. The ring gear 48 can thus be prevented from damage due to incorrect rotation direction.

In some embodiments, after the spindle of the drawer is driven from a predetermined start position to predetermined stop position, the motor is instructed to stop. However, there may be a time delay between a time at which the instruction for stopping the motor is sent to the motor and a time at which the motor finally stops in response to the instruction. There is a possibility that gear components of the clutch is subject to an over-torque. Such an over-torque may cause damages to the gear components of the clutch. In some embodiments, the motor may be configured to perform a reverse rotation for a short time with a reverse current based on a signal indicative that the power shaft 34 arrives at a certain circumferential position. By reverse rotation of the motor with a reverse current, over-tension force in the clutch can be released.

In some embodiments, the racking device may include alarming devices. The alarming devices are configured to provide alarms when the racking device fails. In some embodiments, when the motor is operated with the small current, a first timer may be provided to measure the operation time of the motor and/or the elapsed time after the button is pressed down. If the time exceeds a predetermined time threshold, a failure alarm is sent to the operator. In some embodiments, when the motor is operated with the large current, a current sensor may be provided to detect whether an over-current occurs. If there is an over-current in the circuit, then an over-current failure alarm is sent to the operator. In some embodiments, a second timer may be provided to measure the operation time of the motor operated with the large current. If the time exceeds a predetermined time threshold, a failure alarm is sent to the operator.

FIG. 9 is a flowchart of a method 100 for operating the racking device according to one example embodiment of the present disclosure. As shown in FIG. 9, at a block 102, the motor is caused, based on an instruction for moving the movable drawer 20, to operate with a first current to linearly move the push lever 34 to press down the button 24 in case that the second output shaft 32 is not actuated. At a block 104, the motor is caused, based on the button 24 being pressed down, to operate with a second current greater than the first current so as to rotate the second output shaft 32 to move the movable drawer 20. In some embodiments, the motor is caused to stop based on the movable drawer 20 arriving at the predetermined stop position.

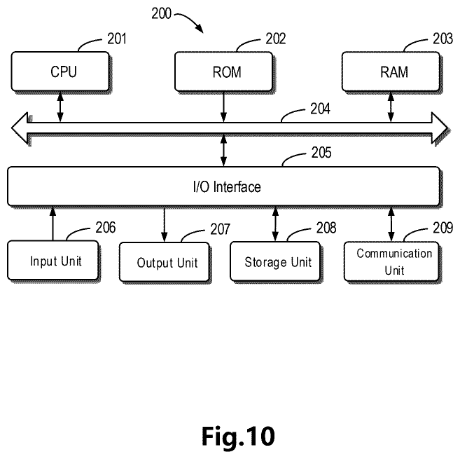

FIG. 10 illustrates a block diagram of an example device 200 adapted to implement the embodiments of the present disclosure. As shown in the figure, a portion of the system in FIGS. 1 and 4 may be implemented by the device 200. As shown in FIG. 2, the device 200 comprises a central processing unit (CPU) 201 that may perform various appropriate actions and processing based on computer program instructions stored in a read-only memory (ROM) 202 or computer program instructions loaded from a memory unit 208 to a random access memory (RAM) 203. In the RAM 203, various programs and data needed for operations of the device 200 may also be stored. The CPU 201, ROM 202 and RAM 203 are connected to each other via a bus 204. An input/output (I/O) interface 205 is also connected to the bus 204.

Various components in the device 200 are connected to the I/O interface 205, including: an input unit 206 such as a keyboard, a mouse and the like; an output unit 207 such as various kinds of displays and a loudspeaker, etc. ; a storage unit 208 such as a magnetic disk, an optical disk, and etc. ; a communication unit 209 such as a network card, a modem, and a wireless communication transceiver, etc. The communication unit 209 allows the device 200 to exchange information/data with other devices through a computer network such as the Internet and/or various kinds of telecommunications networks.

Various processes and processing described above, e.g., method 100, may be executed by the processing unit 201. For example, in some embodiments, the method 100 may be implemented as a computer software program that is tangibly embodied on a machine readable medium, e.g., the storage unit 208. In some embodiments, part or all of the computer program may be loaded and/or mounted onto the device 200 via ROM 202 and/or communication unit 209. When the computer program is loaded to the RAM 203 and executed by the CPU 201, one or more steps of the method 100 as described above may be executed.

Embodiments of the present disclosure relate to a method, device, system and/or computer program product. The computer program product may include a computer readable storage medium on which computer readable program instructions for executing various aspects of the present disclosure are embodied.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/actions specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/actions specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, section, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or actions, or combinations of special purpose hardware and computer instructions.

The description of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A racking device for moving a movable drawer of a switchgear, comprising:
a first output shaft configured to linearly move between a retracted position and an extended position at which a button on the movable drawer is configured to be pressed down by the first output shaft;
a second output shaft configured to rotate a spindle on the movable drawer to move the movable drawer with respect to a fixed part of the switchgear; and
a driver comprising a motor and a transmission mechanism coupled with the motor, the transmission mechanism configured to actuate the second output shaft and the first output shaft.
wherein the motor is configured to:
cause, based on an instruction for moving the movable drawer, the first output shaft to linearly move to press the button in case that the second output shaft is not actuated, and
to cause, based on the button being pressed down, the second output shaft to rotate the second output shaft with a second current greater than the first current to move the movable drawer

2. The racking device of claim 1, wherein the transmission mechanism comprises a planetary gear clutch driven by the motor.

3. The racking device of claim 2, wherein the planetary gear clutch comprises:
a sun gear connected to the motor;
a plurality of planet gears engaged with the sun gear
a carrier configured to support the plurality of planet gears and coupled with the second output shaft to rotate the second output shaft; and
a ring gear engaged with the plurality of planet gears wherein the ring gear is configured to linearly move the first output shaft at a predetermined circumferential position.

4. The racking device of claim 3, wherein the ring gear comprises a pushing structure circumferentially provided at a side adjacent to the first output shaft and configured to linearly move the first output shaft in accordance with a circumferential position of the pushing structure

5. The racking device of claim 3, further comprising at least one rotation resistance mechanism disposed between a housing of the racking device and the carrier and configured to provide a predetermined torque to prevent the carrier from rotating in case that the motor is operated with the first current.

6. The racking device of claim 5, wherein the rotation resistance mechanism comprises:
a plurality of receiving portions circumferentially arranged in the carrier;
a plurality of torsion springs disposed within the respective receiving portion; and
a sliding member sandwiched between an inner surface of the housing and the torsion spring, the sliding member being configured to slide on the inner surface of the housing when the motor is operated with the second current.

7. The racking device of claim 6, wherein the plurality of receiving portions is arranged in at least one axial end surface of the carrier and extends axially,
one end of the plurality of torsion springs is axially received within the plurality of receiving portions; and
the other end of the plurality of torsion springs is arranged against the sliding member.

8. The racking device of claim 6, wherein the plurality of receiving portions is arranged in a circumferential outer surface of the carrier and extends radially;
one end of the plurality of torsion springs is radially received within the plurality of receiving portions; and
the other end of the plurality of torsion springs is arranged on the sliding member.

9. The racking device of claim 6, wherein the sliding member comprises a pin-shaped member comprising:
a base part comprising a flat surface to abut against the inner surface of the housing; and
a pin part extending from the based part and configured to support the torsion spring.

10. The racking device of claim 6, wherein the sliding member comprises a plate-shaped member comprising:
a plate comprising a flat surface to abut against the inner surface of the housing; and
a recess provided in a surface of the plate opposite to the flat surface and configured to receive the torsion spring.

11. The racking device of claim 6, wherein the receiving portion comprises one of an opening, a groove, a recess, or a hole.

12. The racking device of claim 5, further comprising a locking mechanism at a predetermined circumferential position and configured to prevent the ring gear from rotating along a circumferential direction,
wherein the locking mechanism comprises a first stopper provided on one of the ring gear and the housing and a second stopper provided on the other of the ring gear and the housing for cooperating with the first stopper.

13. The racking device of claim 12, wherein the first stopper comprises a protrusion fixedly disposed on the one of the ring gear and the housing, and
the second stopper comprises:
a stopper section for circumferentially engaging the protrusion to stop the protrusion, and
a rail section for circumferentially guiding movement of the protrusion

14. The racking device of claim 1, wherein the motor is further configured to:
rotate in a first direction with a test current;
rotate, based on the rotation in the first direction being hindered, in a second direction opposite to the first direction with the first current; and
rotate, based on the rotation in the first direction being not hindered, to rotate in the first direction with the first current.

15. The racking device of claim 1, further comprising a first sensing device configured to send a first signal indicating that the button is pressed down, the motor being configured to stop rotating in response to receiving the first signal.

16. The racking device of claim 1, further comprising a second sensing device configured to:
send a second signal indicating that the second output shaft arrives at a predetermined position; and
cause the motor to perform, in response to receiving the second signal, a reverse rotation for a predetermined period, with a reverse release current.

17. A switchgear comprising:
a fixed part,
a movable drawer configured to move among a plurality of predetermined positions with respect to the fixing part; and
the racking device according to claim 1 configured to move the movable drawer.

18. A method for operating the racking device according to claim 1, comprising:
causing, based on an instruction for moving the movable drawer, the motor to operate with a first current to linearly move the first output shaft to press down the button in case that the second output shaft is not actuated; and
causing, based on the button being pressed down, the motor to operate with a second current greater than the first current so as to rotate the second output shaft to move the movable drawer.
